(19) United States
(12) Patent Application Publication
(10) Pub. No.: US 2024/0412169 A1
(43) Pub. Date: Dec. 12, 2024

(54) HUMAN RESOURCE DEVELOPMENT SUPPORT DEVICE, HUMAN RESOURCE DEVELOPMENT SUPPORT METHOD, AND PROGRAM

(71) Applicant: Nippon Telegraph and Telephone Corporation, Tokyo (JP)

(72) Inventors: Satoshi TAKATSU, Musashino-shi, Tokyo (JP); Tomoko SHIBATA, Musashino-shi, Tokyo (JP); Hiroshi YOSHIDA, Musashino-shi, Tokyo (JP); Masanobu SAKAMOTO, Musashino-shi, Tokyo (JP)

(21) Appl. No.: 18/709,845

(22) PCT Filed: Dec. 2, 2021
(86) PCT No.: PCT/JP2021/044285

§ 371 Date: May 14, 2024

(51) Int. Cl. G06Q 10/105; G06Q 10/0631

(52) U.S. Cl. CPC G06Q 10/105; G06Q 10/063112

(57) ABSTRACT

The personnel training support device includes an organization unit and a first determination unit. The organization unit is configured to associate a first feature amount corresponding to a first motivation factor for each job on the basis of first information indicating a task content for each job, and associate a second feature amount corresponding to a second motivation factor for each set of a job, a person, and a date and time on the basis of second information indicating a challenge content for each set of a job, a person, and a date and time. The first determination unit is configured to determine whether there is a stimulus by each of the first motivation factor and the second motivation factor or not for each set of a job, a person, and a date and time on the basis of the first feature amount and the second feature amount.

### TECHNICAL FIELD

An embodiment described herein relates to a personnel training support device, a personnel training support method, and a program.

### BACKGROUND ART

In order to efficiently execute a task, it is required to allocate an appropriate person while considering skills and the like required for the task.

For example, a technique for quantitatively learning skills of a person from the result of allocation to past tasks has been proposed. As a result, particularly in a membership-type task that is a business form in which a manager allocates a task to a person, it is possible to mathematically evaluate the suitability degree of the person for the task in the personnel allocation.

### CITATION LIST

### Patent Literature

Patent Literature 1: WO 2021/064881 A

### SUMMARY OF INVENTION

### Technical Problem

With diversification of business forms, business forms other than a membership-type task have attracted attention. For example, in a job-type task, a person selects a job by himself/herself. In the job-type task, there are concerns about the following points.

First, it can be difficult to determine what feature of the job motivates a person. In a job-type task, since the task is subdivided, there are various reasons why a person selects a job. Therefore, information for determining what feature of the job motivates a person may be insufficient.

Moreover, evaluation of an achievement may be difficult. In a job-type task, the suitability based on a factor that motivates a person and the achievement created according to the suitability are evaluated together. Therefore, even if the suitability degree of a person for a task can be grasped, there is a possibility that appropriate evaluation cannot be performed when it is unknown what feature of the job motivates the person.

The present invention has been made in view of the above circumstances, and an object thereof is to provide means for improving an achievement in a job-type task.

### Solution to Problem

A personnel training support device according to an aspect includes: an organization unit configured to associate a first feature amount corresponding to at least one first motivation factor for each job on the basis of first information indicating task content for each job, and associate a second feature amount corresponding to at least one second motivation factor for each set of a job, a person, and a date and time on the basis of second information indicating a challenge content for each set of a job, a person, and a date and time; and a first determination unit configured to determine whether each of the first motivation factor and the second motivation factor is stimulated or not for each set of a job, a person, and a date and time on the basis of the first feature amount and the second feature amount.

### Advantageous Effects of Invention

According to the embodiment, it is possible to provide means for improving an achievement in a job-type task.

### BRIEF DESCRIPTION OF DRAWINGS

FIG. 1 is a block diagram illustrating an example of a hardware configuration of a personnel training support device according to an embodiment.

FIG. 2 is a block diagram illustrating an example of a functional configuration of the personnel training support device according to the embodiment.

FIG. 3 is a diagram illustrating an example of a configuration of task content information according to the embodiment.

FIG. 4 is a diagram illustrating an example of a configuration of challenge content information according to the embodiment.

FIG. 5 is a diagram illustrating an example of a configuration of job achievement information according to the embodiment.

FIG. 6 is a diagram illustrating an example of a configuration of task contrivance information according to the embodiment.

FIG. 7 is a flowchart illustrating an example of motivation determination processing in the personnel training support device according to the embodiment.

FIG. 8 is a diagram illustrating an example of a first part of the motivation determination processing in the personnel training support device according to the embodiment.

FIG. 9 is a diagram illustrating an example of a second part of the motivation determination processing in the personnel training support device according to the embodiment.

FIG. 10 is a diagram illustrating an example of a third part of the motivation determination processing in the personnel training support device according to the embodiment.

FIG. 11 is a flowchart illustrating an example of achievement determination processing in the personnel training support device according to the embodiment.

FIG. 12 is a diagram illustrating an example of achievement determination processing in the personnel training support device according to the embodiment.

FIG. 13 is a flowchart illustrating an example of diagnosis processing in the personnel training support device according to the embodiment.

FIG. 14 is a diagram illustrating an example of a first part of the diagnosis processing in the personnel training support device according to the embodiment.

FIG. 15 is a diagram illustrating an example of a second part of the diagnosis processing in the personnel training support device according to the embodiment.

FIG. 16 is a diagram illustrating an example of a third part of the diagnosis processing in the personnel training support device according to the embodiment.

FIG. 17 is a diagram illustrating an example of a fourth part of the diagnosis processing in the personnel training support device according to the embodiment.

FIG. 18 is a diagram illustrating an example of a fifth part of the diagnosis processing in the personnel training support device according to the embodiment.

FIG. 19 is a flowchart illustrating an example of task contrivance proposal processing in the personnel training support device according to the embodiment.

FIG. 20 is a diagram illustrating an example of task contrivance proposal processing in the personnel training support device according to the embodiment.

FIG. 21 is a flowchart illustrating an example of personnel transfer proposal processing in the personnel training support device according to the embodiment.

FIG. 22 is a diagram illustrating an example of personnel transfer proposal processing in the personnel training support device according to the embodiment.

FIG. 23 is a flowchart illustrating an example of job construction proposal processing in the personnel training support device according to the embodiment.

FIG. 24 is a diagram illustrating an example of job construction proposal processing in the personnel training support device according to the embodiment.

### DESCRIPTION OF EMBODIMENTS

Hereinafter, an embodiment will be described with reference to the drawings. Note that in the following description, components having the same function and configuration are denoted by a common reference sign. Moreover, when distinguishing among a plurality of components having a common reference sign, the components are distinguished by additional reference signs (e.g., hyphens and numbers such as “−1”) attached after the common reference sign.

### 1. Configuration

A configuration of a personnel training support device according to an embodiment will be described.

### 1.1 Hardware Configuration

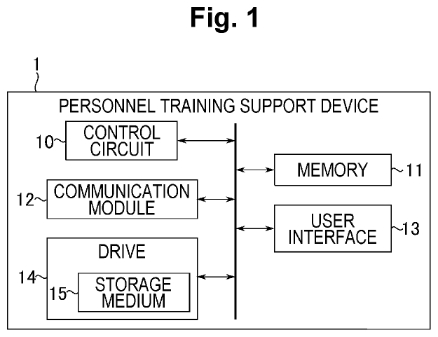

FIG. 1 is a block diagram illustrating an example of a hardware configuration of a personnel training support device according to the embodiment. As illustrated in FIG. 1, a personnel training support device 1 includes a control circuit 10, a memory 11, a communication module 12, a user interface 13, and a drive 14.

The control circuit 10 is a circuit that entirely controls each component of the personnel training support device 1. The control circuit 10 includes a central processing unit (CPU), a random access memory (RAM), a read only memory (ROM), and the like.

The memory 11 is an auxiliary storage device of the personnel training support device 1. The memory 11 includes, for example, a hard disk drive (HDD), a solid state drive (SSD), a memory card, and the like. The memory 11 stores various types of information used for personnel training support operation, and a personnel training support program. The personnel training support program can be stored in the memory 11 by being transmitted from the outside of the personnel training support device 1 via a network (not illustrated).

The personnel training support operation is a series of operations executed to support improvement of an achievement in a job-type task. The personnel training support program is a program for causing the personnel training support device 1 to execute personnel training support operation. Details of the personnel training support operation will be described below.

The communication module 12 is a circuit used for transmission and reception of data via a network.

The user interface 13 is a circuit for communicating information between a user and the control circuit 10. The user interface 13 includes an input device and an output device. The input device includes, for example, a touch panel, an operation button, and the like. The output device includes, for example, a liquid crystal display (LCD), an electroluminescence (EL) display, and a printer. The user interface 13 converts input by the user (user input) into an electrical signal, and then transmits the electrical signal to the control circuit 10. The user interface 13 outputs a result of execution of the personnel training support program received from the control circuit 10 to the user.

The drive 14 is a device for reading a program stored in a storage medium 15. The drive 14 includes, for example, a compact disk (CD) drive, a digital versatile disk (DVD) drive, and the like.

The storage medium 15 is a medium that accumulates information such as programs by electrical, magnetic, optical, mechanical, or chemical action. The storage medium 15 may store the personnel training support program.

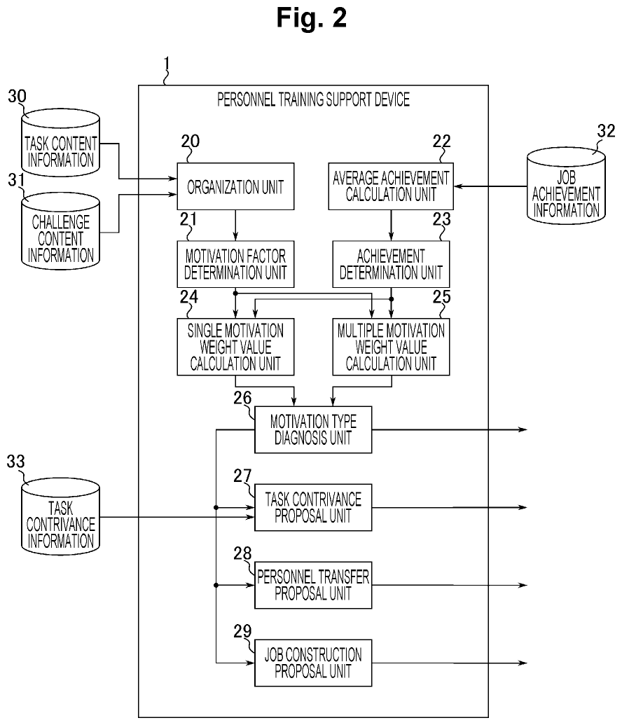

1.2 Functional Configuration FIG. 2 is a block diagram illustrating an example of a functional configuration of the personnel training support device according to the embodiment.

The CPU of the control circuit 10 develops the personnel training support program stored in the memory 11 or the storage medium 15 in the RAM. Then, the CPU of the control circuit 10 interprets and executes the personnel training support program developed in the RAM to control the memory 11, the communication module 12, the user interface 13, the drive 14, and the storage medium 15. As a result, as illustrated in FIG. 2, the personnel training support device 1 functions as a computer including an organization unit 20, a motivation factor determination unit 21, an average achievement calculation unit 22, an achievement determination unit 23, a single motivation weight value calculation unit 24, a multiple motivation weight value calculation unit 25, a motivation type diagnosis unit 26, a task contrivance proposal unit 27, a personnel transfer proposal unit 28, and a job construction proposal unit 29. Moreover, task content information 30, challenge content information 31, job achievement information 32, and task contrivance information 33 are inputted to the personnel training support device 1 by, for example, input by the user.

The organization unit 20 associates a job with the first feature amount corresponding to the motivation factor on the basis of the task content information 30. The organization unit 20 associates a job with the second feature amount corresponding to the motivation factor on the basis of the challenge content information 31. The organization unit 20 organizes information in which the job is associated with the first feature amount and the second feature amount, and transmits the information to the motivation factor determination unit 21.

Here, the job is, for example, an individual task process executed in a certain organization, and is defined as a minimum unit of a task, for which an achievement and a stimulus can be grasped. Specifically, when assuming an organization that constructs a communication infrastructure, the job in the organization includes, for example, utility pole inspection, manhole inspection, home network setting, cable filling, and the like.

The motivation factor is a factor that motivates a person. The motivation factor is determined genetically and in early childhood. Therefore, it is considered that the motivation factor does not change from 18 years old or older. The motivation factor includes, for example, reward motivation, others-oriented motivation, specialty motivation, power motivation, fear motivation, expectation motivation, accomplishment motivation, and avoidance motivation.

The reward motivation is a motivation factor due to a desire for money or gratitude. A person motivated by the reward motivation tends to make more achievements as money or gratitude are satisfied.

The others-oriented motivation is a motivation factor due to a desire to work for people. A person motivated by the others-oriented motivation tends to make more achievements when working in groups rather than as an individual.

The specialty motivation is a motivation factor due to a desire to demonstrate one's ability. A person motivated by the specialty motivation tends to make more achievements as he/she can demonstrate his/her ability.

The power motivation is a motivation factor due to a desire to be ranked above others and manage a task. A person motivated by the power motivation tends to make more achievements in an environment where he/she can show off power.

The fear motivation is a motivation factor due to a desire to avoid one's disadvantage. A person motivated by the fear motivation tends to make more short-time achievements in an environment where there is a penalty.

The expectation motivation is a motivation factor due to a desire to obtain an expected reward under a fair evaluation. A person motivated by the expectation motivation tends to make more achievements when quantitative evaluation and reward are clearly linked.

The accomplishment motivation is a motivation factor due to a desire to make more achievements than the average of surroundings and oneself. A person motivated by the accomplishment motivation tends to make more achievements when a target is set.

The avoidance motivation is a motivation factor due to a desire to avoid what one would not be able to accomplish. A person motivated by the avoidance motivation tends to make less achievements when a target is set.

The first feature amount is a feature amount associated with the reward motivation, the others-oriented motivation, the specialty motivation, the power motivation, the fear motivation, and the expectation motivation among the above-described motivation factors. The second feature amount is a feature amount associated with the accomplishment motivation and the avoidance motivation among the above-described motivation factors.

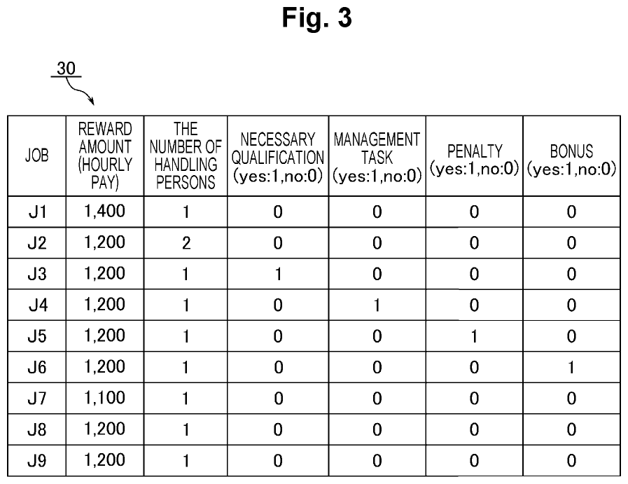

FIG. 3 is a diagram illustrating an example of task content information according to the embodiment.

In each record including a plurality of records in the task content information 30, a task content such as a necessary resource, an essential condition, and a task rule is associated with a job. The necessary resource includes, for example, a reward and the number of handling persons. The reward may be, for example, a reward amount in the case of paid work, and may be, for example, gratitude from others in the case of unpaid work or volunteer work. The essential condition includes, for example, information indicating whether a qualification such as a normal vehicle license is necessary or not. The task rule includes, for example, detailed information of a job such as whether the job is a management task or not, whether there is a penalty when the target is not accomplished or not, or whether a bonus is paid or not. The penalty is occurrence of disadvantage such as a decrease in reward, reproof, complaint, or a decrease in evaluation. The bonus is any thing or matter that a person feels happy to receive such as prize, a gift certificate, a medal, or a letter of appreciation.

In the example in FIG. 3, a use case is assumed in which there are nine types of jobs J1 to J9 in one organization. Specifically, for example, the job J1 is a task for which the hourly pay is 1, 400 yen, the quota is 1, and there is no necessary qualification, no management task, no penalty, and no bonus. The job J2 is a task for which the hourly pay is 1, 200 yen, the quota is 2, and there are no necessary qualification, no management task, no penalty, and no bonus. The job J3 is a task for which the hourly pay is 1,200 yen, the quota is 1, there is a necessary qualification, and there are no management task, no penalty, and no bonus. The job J4 is a task for which the hourly pay is 1,200 yen, the quota is 1, there is a management task, and there is no necessary qualification, no penalty, and no bonus. The job J5 is a task for which the hourly pay is 1, 200 yen, the quota is 1, there is a penalty, and there is no necessary qualification, no management task, and no bonus. The job J6 is a task for which the hourly pay is 1,200 yen, the quota is 1, there is a bonus, and there is no necessary qualification, no management task, and no penalty. The job J7 is a task for which the hourly pay is 1, 100 yen, the quota is 1, and there is no necessary qualification, no management task, no penalty, and no bonus. The jobs J8 and J9 are tasks for which the hourly pay is 1,200 yen, the quota is 1, and there is no necessary qualification, no management task, no penalty, and no bonus.

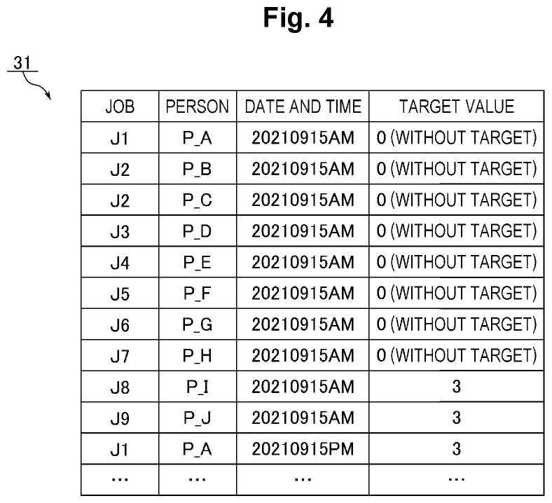

FIG. 4 is a diagram illustrating an example of challenge content information according to the embodiment.

The challenge content information 31 includes a plurality of records. In each record, an achievement target is quantitatively associated as a challenge content with respect to a job executed by a certain person at a certain date and time.

In the example in FIG. 4, some of jobs executed on Sep. 15, 2021, are illustrated. Specifically, for example, it is indicated that a person P_A executed the job J1 in the morning without setting a target value (setting a target value 0). It is also indicated that persons P_B and P_C executed the job J2 without setting a target value. It is also indicated that persons P_D to P_H respectively executed the jobs J3 to J7 without setting a target value. It is also indicated that persons P_I and P_J set a target value 3 and respectively executed the jobs J8 and J9. Moreover, it is indicated that the person P_A set a target value 3 and executed the job J1 In the afternoon.

Note that, in a case where it is difficult to quantitatively indicate the target of the achievement, the presence or absence of the target may be set as the target value. That is, a target value 1 may be set in a case where there is a target, and a target value 0 may be set in a case where there is no target.

Returning to FIG. 2 again, a functional configuration of the personnel training support device 1 will be described.

The motivation factor determination unit 21 determines a motivation factor stimulated by a job for each job on the basis of the first feature amount. Moreover, the motivation factor determination unit 21 determines a motivation factor stimulated by the job for each person and each date and time on the basis of the second feature amount. After integrating these determination results, the motivation factor determination unit 21 transmits the integrated determination results to the single motivation weight value calculation unit 24 and the multiple motivation weight value calculation unit 25.

Hereinafter, the processing by the organization unit 20 and the motivation factor determination unit 21 will be also referred to as motivation determination processing.

The average achievement calculation unit 22 calculates an average value of achievements for each job made by each person as an average achievement on the basis of the job achievement information 32. The average achievement calculation unit 22 transmits the calculated average achievement to the achievement determination unit 23.

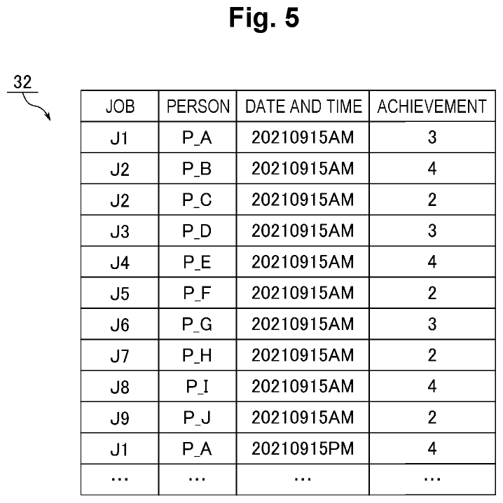

FIG. 5 is a diagram illustrating an example of job achievement information according to the embodiment.

The job achievement information 32 includes a plurality of records. In each record, a person who executed a job, a date and time when the job was executed, and a quantitative value of an obtained achievement are associated with each job.

In the example in FIG. 5, some of jobs executed on Sep. 15, 2021, are illustrated. Specifically, for example, it is indicated that the person P_A executed the job J1 and made an achievement 3 in the morning. It is also indicated that the persons P_B and P_C executed the job J2 and respectively made achievements 4 and 2. It is also indicated that the persons P_D to P_J executed the jobs J3 to J9 and respectively made achievements 3, 4, 2, 3, 2, 4, and 2. Moreover, it is also indicated that the person P_A executed the job J1 and made an achievement 4 in the afternoon.

Returning to FIG. 2 again, a functional configuration of the personnel training support device 1 will be described.

The achievement determination unit 23 determines whether the achievement made by each person exceeds the average achievement or not for each job and each date and time on the basis of the job achievement information 32 and the average achievement. The achievement determination unit 23 transmits the determination result to the single motivation weight value calculation unit 24 and the multiple motivation weight value calculation unit 25.

Hereinafter, the processing by the average achievement calculation unit 22 and the achievement determination unit 23 will be also referred to as achievement determination processing.

The single motivation weight value calculation unit 24 calculates a single motivation weight value for each combination of a job, a person, and a date and time on the basis of the result of the motivation determination processing and the result of the achievement determination processing. In a case where there is one motivation factor stimulated by a job, the single motivation weight value is a weight value associated with the one motivation factor. The single motivation weight value calculation unit 24 transmits the calculated single motivation weight value to the motivation type diagnosis unit 26.

The multiple motivation weight value calculation unit 25 calculates a multiple motivation weight value for each combination of a job, a person, and a date and time on the basis of the determination result obtained by the motivation factor determination unit 21 and the determination result obtained by the achievement determination unit 23. In a case where there are a plurality of motivation factors stimulated by a job, the multiple motivation weight value is a weight value associated with the plurality of motivation factors. The multiple motivation weight value calculation unit 25 transmits the calculated multiple motivation weight value to the motivation type diagnosis unit 26.

The motivation type diagnosis unit 26 diagnoses the motivation type for each person on the basis of the single motivation weight value and the multiple motivation weight value. The motivation type is a set of a plurality of motivation factors that are likely to stimulate a person to make more achievements. The motivation type diagnosis unit 26 transmits the diagnosis result of the motivation type to the task contrivance proposal unit 27, the personnel transfer proposal unit 28, and the job construction proposal unit 29. Moreover, the motivation type diagnosis unit 26 outputs the diagnosis result of the motivation type to the user.

Hereinafter, the processing by the single motivation weight value calculation unit 24, the multiple motivation weight value calculation unit 25, and the motivation type diagnosis unit 26 will be also referred to as diagnosis processing.

The task contrivance proposal unit 27 generates a proposal regarding task contrivance for each person on the basis of the task contrivance information 33, the result of the achievement determination processing, and the result of the diagnosis processing. The task contrivance proposal unit 27 outputs the generated proposal regarding a task contrivance to the user.

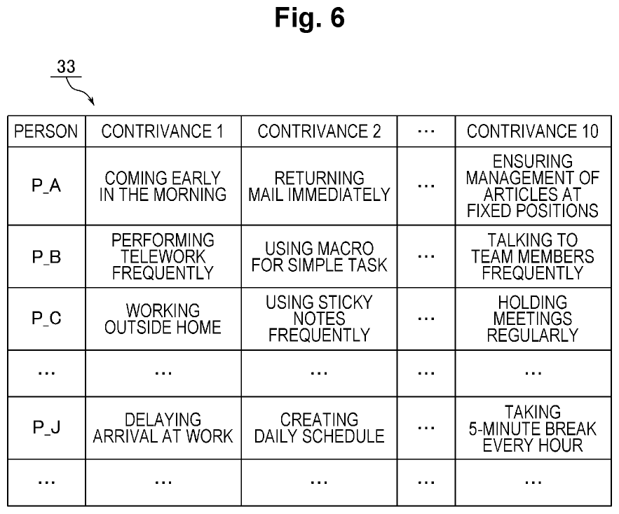

FIG. 6 is a diagram illustrating an example of task contrivance information according to the embodiment.

The task contrivance information 33 includes a plurality of records. In each record, at least one task contrivance performed during task execution is associated with a person.

In the example in FIG. 6, it is indicated that the person P_A makes task contrivances such as “Coming early in the morning”, “Returning mail immediately”, . . . , and “Ensuring management of articles at fixed positions”. It is also indicated that the person P_B makes task contrivances such as “Performing telework frequently”, “Using macro for simple task”, . . . , and “Talking to team members frequently”. It is also indicated that the person P_C makes task contrivances such as “Working outside home”, “Using sticky notes frequently”, . . . , and “holding meetings regularly”. It is also indicated that the person P_J makes task contrivances such as “Delaying arrival at work”, “Creating daily schedule”, . . . , and “Taking 5-minute break every hour”.

Returning to FIG. 2 again, a functional configuration of the personnel training support device 1 will be described.

The personnel transfer proposal unit 28 generates a proposal regarding personnel transfer for each person on the basis of the job achievement information 32, the determination result obtained by the motivation factor determination unit 21, and the diagnosis result of the motivation type. The personnel transfer proposal unit 28 outputs the generated proposal regarding personnel transfer to the user.

The job construction proposal unit 29 generates a proposal regarding job construction on the basis of the job achievement information 32, the determination result obtained by the motivation factor determination unit 21, and the diagnosis result of the motivation type. The job construction proposal unit 29 outputs the generated proposal regarding job construction to the user.

Hereinafter, the processing by the task contrivance proposal unit 27, the personnel transfer proposal unit 28, and the job construction proposal unit 29 will be also referred to as task contrivance proposal processing, personnel transfer proposal processing, and job construction proposal processing, respectively.

With the above configuration, the user can grasp various types of information regarding personnel training. Then, the user can realize appropriate arrangement of persons capable of maximizing achievements in the job proposal type on the basis of the information.

### 2. Operation

Next, the personnel training support operation in the personnel training support device according to the embodiment will be described.

The personnel training support operation includes motivation determination processing, achievement determination processing, diagnosis processing, task contrivance proposal processing, personnel transfer proposal processing, and job construction proposal processing.

### 2.1 Motivation Determination Processing

First, motivation determination processing in the personnel training support device according to the embodiment will be described.

### 2.1.1 Flowchart

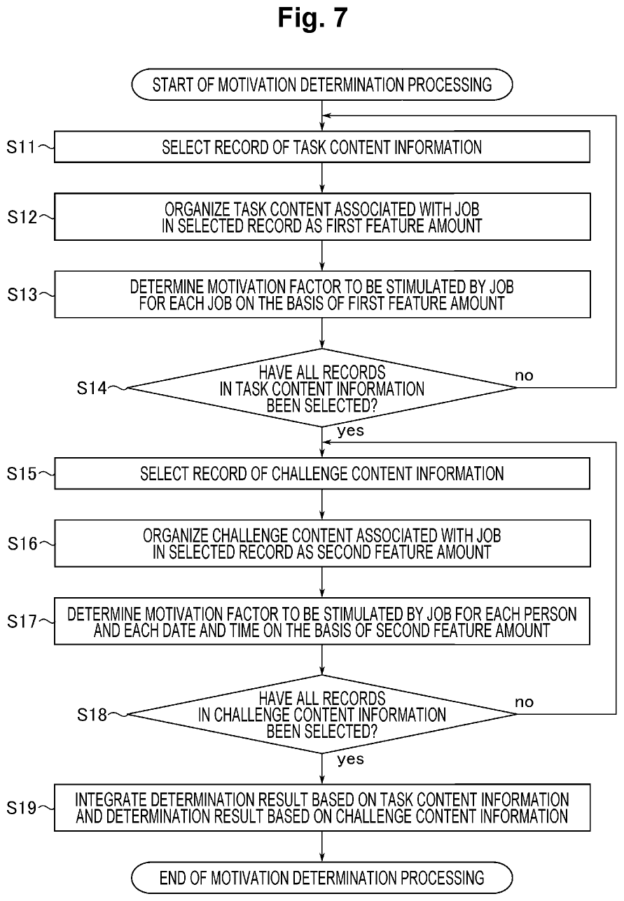

FIG. 7 is a flowchart illustrating an example of motivation determination processing in the personnel training support device according to the embodiment. In the example in FIG. 7, it is assumed that the task content information 30 and the challenge content information 31 are inputted in advance to the personnel training support device 1 by the user.

As illustrated in FIG. 7, when an instruction to execute the motivation determination processing is received from the user (Start), the organization unit 20 selects a record in the task content information 30 (S11).

The organization unit 20 organizes task contents associated with a job in the record selected in the process of S11 as the first feature amount (S12).

The motivation factor determination unit 21 determines a motivation factor stimulated by the job in the selected record, on the basis of the first feature amount organized in the process of S12 (S13).

The organization unit 20 determines whether all records in the task content information 30 have been selected or not (S14).

In a case where there is a record that has not been selected in the task content information 30 (S14; no), the organization unit 20 selects an unselected record in the task content information 30 (S11). In this manner, the process of S11 to S14 are repeated until all records in the task content information 30 are selected.

In case where all records in the task content information 30 have been selected (S14; yes), the organization unit 20 selects a record in the challenge content information 31 (S15).

The organization unit 20 organizes challenge contents associated with a job in the record selected in the process of S15 as the second feature amount (S16).

The motivation factor determination unit 21 determines a motivation factor stimulated by the job in the selected record for each person and each date and time, on the basis of the second feature amount organized in the process of S16 (S17).

The organization unit 20 determines whether all records in the challenge content information 31 have been selected or not (S18).

In a case where there is a record that has not been selected in the challenge content information 31 (S18; no), the organization unit 20 selects an unselected record in the challenge content information 31 (S15). In this manner, the process of S15 to S18 is repeated until all records in the challenge content information 31 are selected.

In a case where all records in the challenge content information 31 have been selected (S18; yes), the motivation factor determination unit 21 integrates a determination result based on the task content information 30 obtained from the process of S13 and a determination result based on the challenge content information 31 obtained from the process of S17 (S19). The motivation factor determination unit 21 transmits the information integrated in S19 to the single motivation weight value calculation unit 24 and the multiple motivation weight value calculation unit 25 as a result of the motivation determination processing.

When the process of S19 ends, the motivation determination processing ends (End).

### 2.1.2 Specific Example

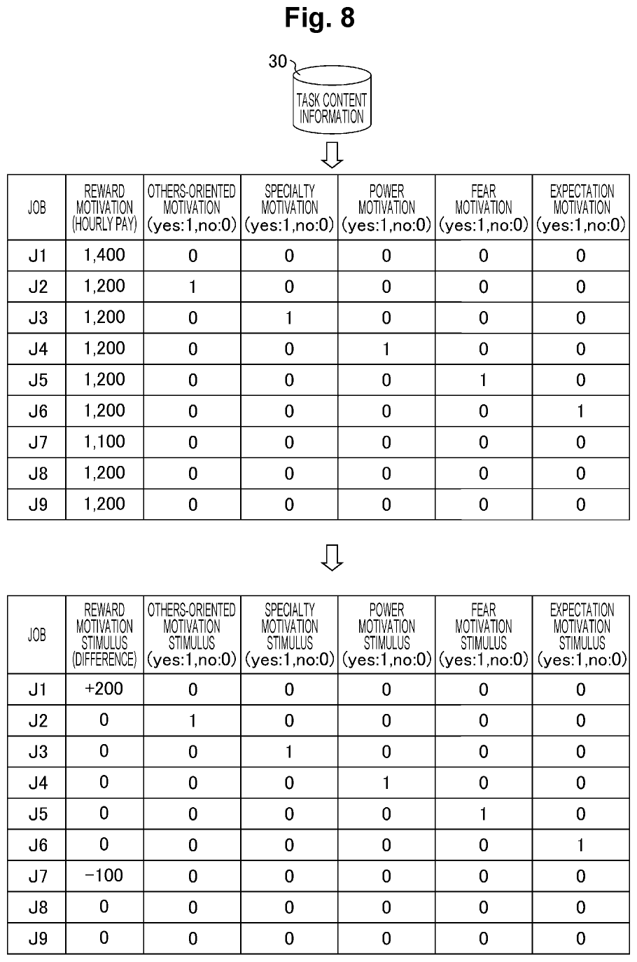

FIGS. 8 to 10 are diagrams respectively illustrating an example of first to third parts of the motivation determination processing in the personnel training support device according to the embodiment. The first to third parts of the motivation determination processing respectively correspond to the process of S12 and S13, the process of S16 and S17, and the process of S19 in FIG. 7. The example in FIGS. 8 to 10 illustrate a case where the task content information 30 illustrated in FIG. 3 and the challenge content information 31 illustrated in FIG. 4 are applied.

First, a specific example of the process of S12 and S13 will be described with reference to FIG. 8.

As illustrated in the upper part of FIG. 8, columns corresponding to the reward amount, the number of handling persons, the necessary qualification, the management task, the penalty, and the bonus are organized respectively for each record in the task content information 30 as first feature amounts corresponding to the reward motivation, the others-oriented motivation, the specialty motivation, the power motivation, the fear motivation, and the expectation motivation in the process of S12.

Specifically, the value of the column of the reward amount is inputted to the column of the reward motivation.

In a case where the value of the column of the number of handling persons is 1, 0 is inputted to the column of the others-oriented motivation. In a case where the value of the column of the number of handling persons is 2 or more, 1 is inputted to the column of the others-oriented motivation.

In a case where the values of the columns of the necessary qualification, the management task, the penalty, and the bonus are 0, 0 is inputted to each of the columns of the specialty motivation, the power motivation, the fear motivation, and the expectation motivation. In a case where the values of the columns of the necessary qualification, the management task, the penalty, and the bonus are 1, 1 is inputted to each of the columns of the specialty motivation, the power motivation, the fear motivation, and the expectation motivation.

As illustrated in the lower part of FIG. 8, whether a job stimulates each of the reward motivation, the others-oriented motivation, the specialty motivation, the power motivation, the fear motivation, and the expectation motivation or not is determined in the process of S13.

Specifically, a difference between the value of the column of the reward motivation and the average value of the reward is inputted to the column of reward motivation stimulus as a determination result. As a result, in a case where the value of the column of reward motivation stimulus is positive, the motivation factor determination unit 21 determines that the job has stimulated positive reward motivation. In a case where the value of the column of reward motivation stimulus is negative, the motivation factor determination unit 21 determines that the job has stimulated negative reward motivation. In a case where the value of the column of reward motivation stimulus is 0, the motivation factor determination unit 21 determines that the job has not stimulated the reward motivation. In the example in FIG. 8, a case where the average value of the reward is 1, 200 yen is illustrated. In this case, the reward motivation stimulus for the job J1 is expressed as 1400−1200=+200. The reward motivation stimulus for the jobs J2 to J6, J8, and J9 is expressed as 1200−1200=0. Moreover, the reward motivation stimulus for the job J7 is expressed as 1100−1200=−100.

Moreover, the values of the columns of the others-oriented motivation, the specialty motivation, the power motivation, the fear motivation, and the expectation motivation are inputted respectively to the values of the columns of the others-oriented motivation stimulus, the specialty motivation stimulus, the power motivation stimulus, the fear motivation stimulus, and the expectation motivation stimulus as determination results. As a result, in a case where the values of the columns of the others-oriented motivation stimulus, the specialty motivation stimulus, the power motivation stimulus, the fear motivation stimulus, and the expectation motivation stimulus are 1, the motivation factor determination unit 21 determines that the job has stimulated each of the others-oriented motivation, the specialty motivation, the power motivation, the fear motivation, and the expectation motivation. In a case where the values of the columns of the others-oriented motivation stimulus, the specialty motivation stimulus, the power motivation stimulus, the fear motivation stimulus, and the expectation motivation stimulus are 0, the motivation factor determination unit 21 determines that the job has not stimulated each of the others-oriented motivation, the specialty motivation, the power motivation, the fear motivation, and the expectation motivation.

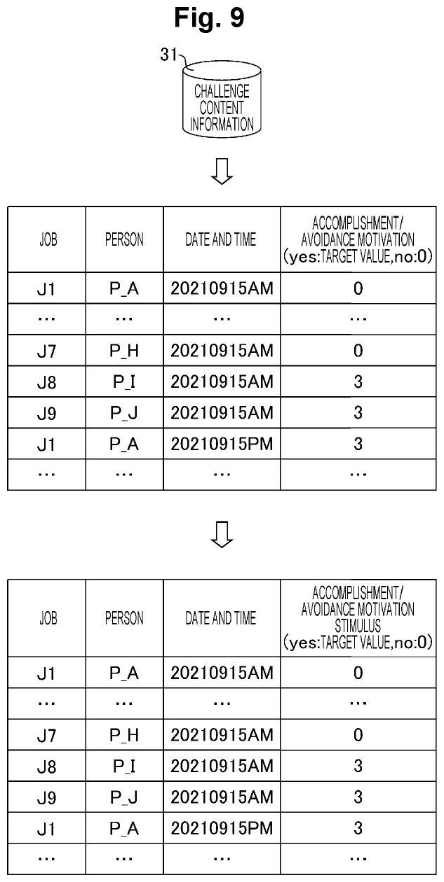

Next, a specific example of the process of S16 and S17 will be described with reference to FIG. 9.

As illustrated in the upper part of FIG. 9, a column corresponding to the target value is organized for each record in the challenge content information 31 in the process of S16 as the second feature amount corresponding to the accomplishment/avoidance motivation. Specifically, the value of the target value column is inputted to the accomplishment/avoidance motivation column.

As illustrated in the lower part of FIG. 9, whether the job stimulates the accomplishment motivation or the avoidance motivation or not is determined in the process of S17. Specifically, the value of the column of the accomplishment/avoidance motivation is inputted to the value of the column of the accomplishment/avoidance motivation stimulus as a determination result. As a result, in a case where the value of the column of the accomplishment/avoidance motivation stimulus is 1 or more, the motivation factor determination unit 21 determines that the job has stimulated the accomplishment motivation or the avoidance motivation. In a case where the value of the column of the accomplishment/avoidance motivation stimulus is 0, the motivation factor determination unit 21 determines that the job has not stimulated the accomplishment motivation or the avoidance motivation.

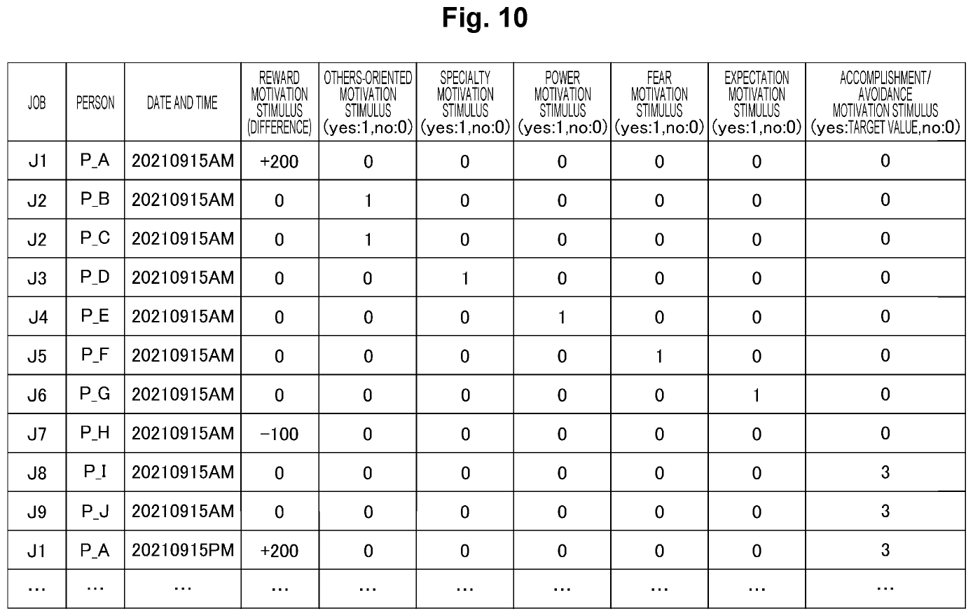

Next, a specific example of the process of S19 will be described with reference to FIG. 10.

As illustrated in FIG. 10, the result of the process of S13 illustrated in the lower part of FIG. 8 and the result of the process of S17 illustrated in the lower part of FIG. 9 are integrated. As a result, information indicating which motivation factor is stimulated by the job is aggregated as one record for each set of a person and a date and time. The motivation factor determination unit 21 transmits the information illustrated in FIG. 10 to the single motivation weight value calculation unit 24 and the multiple motivation weight value calculation unit 25 as a result of the motivation determination processing.

### 2.2 Achievement Determination Processing

Next, achievement determination processing in the personnel training support device according to the embodiment will be described.

### 2.2.1 Flowchart

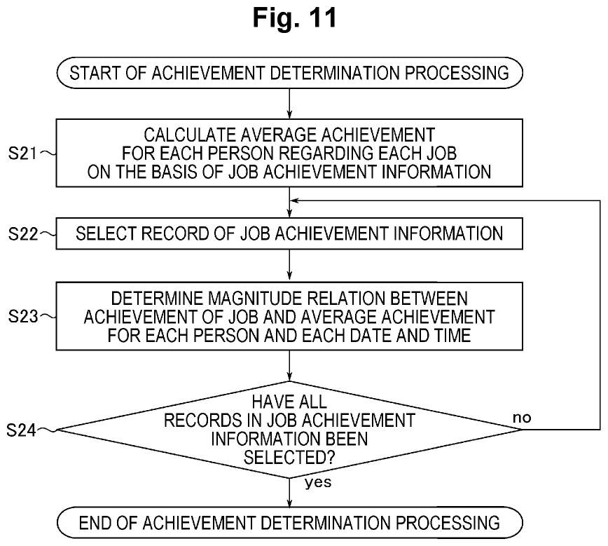

FIG. 11 is a flowchart illustrating an example of achievement determination processing in the personnel training support device according to the embodiment. In the example in FIG. 11, it is assumed that the job achievement information 32 is inputted in advance to the personnel training support device 1 by the user.

As illustrated in FIG. 11, when an instruction to execute the achievement determination processing is received from the user (Start), the average achievement calculation unit 22 calculates an average achievement for each person for each job on the basis of the job achievement information 32 (S21).

After the process of S21, the achievement determination unit 23 selects a record in the job achievement information 32 (S22).

The achievement determination unit 23 determines a magnitude relation between an achievement of the job in the record selected in the process of S22 and the average achievement calculated in the process of S21 for each person and each date and time (S23).

The achievement determination unit 23 determines whether all records in the job achievement information 32 have been selected or not (S24).

In a case where there is a record that has not been selected in the job achievement information 32 (S24; no), the achievement determination unit 23 selects an unselected record in the job achievement information 32 (S22). In this manner, the process of S22 to S24 is repeated until all records in the job achievement information 32 are selected.

When all records in the job achievement information 32 have been selected (S24; yes), the achievement determination processing ends (End). That is, the achievement determination unit 23 transmits the determination result obtained in the process of S23 to the single motivation weight value calculation unit 24 and the multiple motivation weight value calculation unit 25 as a result of the achievement determination processing.

### 2.2.2 Specific Example

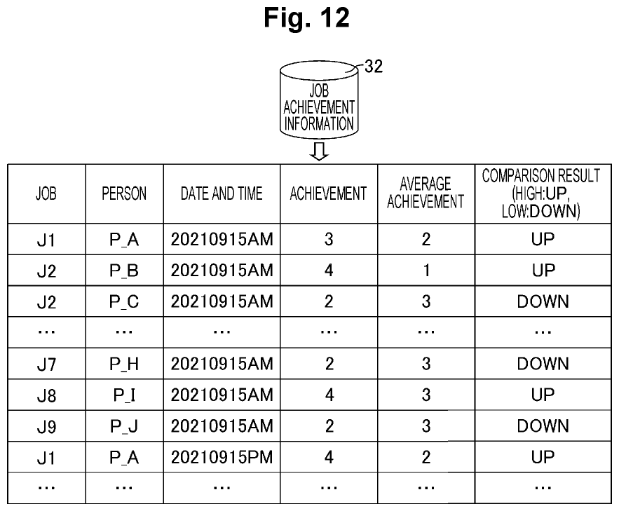

FIG. 12 is a diagram illustrating an example of achievement determination processing in the personnel training support device according to the embodiment. FIG. 12 corresponds to the process of S21 and S23 in FIG. 11. In the example in FIG. 12, a case where the job achievement information 32 illustrated in FIG. 5 is applied is illustrated.

As illustrated in FIG. 12, an average achievement for each person for each job is calculated on the basis of the job achievement information 32 in the process of S21. In the example in FIG. 12, it is indicated that the average achievement of the job J1 by the person P_A is 2. It is also indicated that the average achievement of the job J2 by the persons P_B and P_C are respectively 1 and 3. It is also indicated that the average achievement of the jobs J7 to J9 by the persons P_H to P_J are all 3.

Then, the actual achievement for each person and each date and time for each job is compared with the average achievement in the process of S23. In the example in FIG. 12, it is indicated that the achievements of the persons P_A to P_C in the morning are respectively high (UP), high (UP), and low (DOWN) in comparison with the average achievement. It is also indicated that the achievements of the persons P_H to P_J are respectively low (DOWN), high (UP), and low (DOWN) in comparison with the average achievement. Moreover, it is also indicated that the achievement of the person P_A in the afternoon is high (UP) in comparison with the average achievement.

As a result, information indicating whether the achievement of the job is higher than the average achievement or not is aggregated into one record for each set of a person and a date and time. The achievement determination unit 23 transmits information illustrated in FIG. 12 to the single motivation weight value calculation unit 24 and the multiple motivation weight value calculation unit 25 as a result of the achievement determination processing.

### 2.3 Diagnosis Processing

Next, diagnosis processing in the personnel training support device according to the embodiment will be described.

### 2.3.1 Flowchart

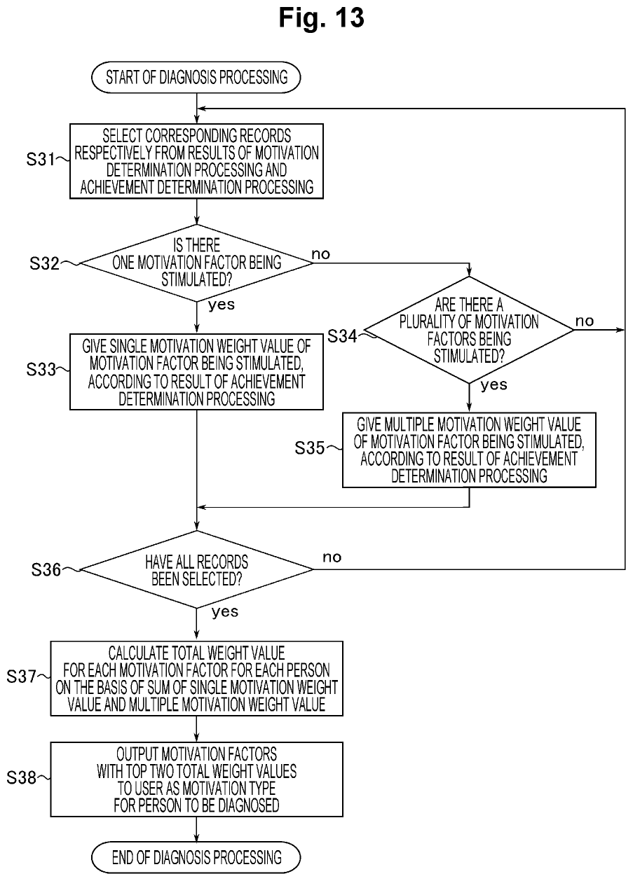

FIG. 13 is a flowchart illustrating an example of diagnosis processing in the personnel training support device according to the embodiment. In the example in FIG. 13, it is assumed that the motivation determination processing and the achievement determination processing are executed in advance.

As illustrated in FIG. 13, when an instruction to execute the diagnosis processing is received from the user (Start), each of the single motivation weight value calculation unit 24 and the multiple motivation weight value calculation unit 25 selects a corresponding record from the results of the motivation determination processing and the achievement determination processing (S31).

The single motivation weight value calculation unit 24 determines whether there is one motivation factor stimulated in the record selected in the process of S31 or not (S32).

In a case where there is one motivation factor being stimulated (S32; yes), the single motivation weight value calculation unit 24 calculates the single motivation weight value corresponding to the one motivation factor being stimulated, according to the result of the achievement determination processing (S33).

In a case where there is not one motivation factor being stimulated (S32; no), the multiple motivation weight value calculation unit 25 determines whether a plurality of motivation factors is stimulated in the record selected in the process of S31 or not (S34).

In a case where there are a plurality of motivation factors being stimulated (S34; yes), the multiple motivation weight value calculation unit 25 calculates a multiple motivation weight value corresponding to each of the plurality of motivation factors being stimulated, according to the result of the achievement determination processing (S35).

After the process of S33 or S35, the motivation type diagnosis unit 26 determines whether all records of the results of the motivation determination processing and the achievement determination processing have been selected or not (S36).

In a case where there is a record that has not been selected in the results of the motivation determination processing and the achievement determination processing (S36; no), or in a case where there is no motivation factor being stimulated (S34; no), each of the single motivation weight value calculation unit 24 and the multiple motivation weight value calculation unit 25 selects a corresponding record from the results of the motivation determination processing and the achievement determination processing (S31). In this manner, the process of S31 to S36 is repeated until all records are selected from the results of the motivation determination processing and the achievement determination processing.

In a case where all records of the results of the motivation determination processing and the achievement determination processing have been selected (S36; yes), the motivation type diagnosis unit 26 calculates a total weight value for each motivation factor for each person on the basis of the single motivation weight value and the multiple motivation weight value respectively calculated in the processes of S33 and S35 (S37).

Then, the motivation type diagnosis unit 26 outputs motivation factors with top two among the total weight values for each motivation factor calculated in the process of S37 to the user as the “motivation type” for the person to be diagnosed (S38).

When the process of S38 ends, the diagnosis processing ends (End).

### 2.3.2 Specific Example

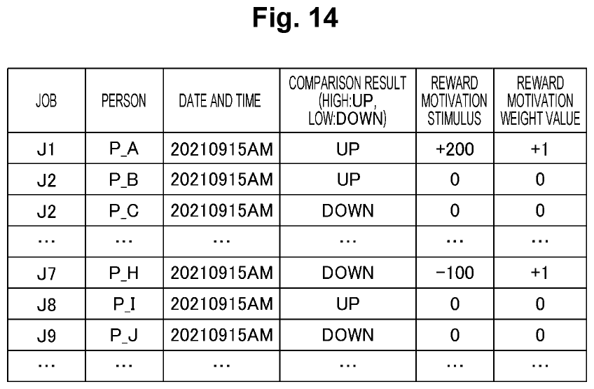

FIGS. 14 to 18 are diagrams respectively illustrating an example of first to fifth parts of the diagnosis processing in the personnel training support device according to the embodiment. The first part of the diagnosis processing corresponds to a process of calculating the single motivation weight value of the reward motivation in the process of S33 in FIG. 13. The second part of the diagnosis processing corresponds to a process of calculating the single motivation weight value of the others-oriented motivation in the process of S33 in FIG. 13. The third part of the diagnosis processing corresponds to a process of calculating the single motivation weight values of the accomplishment motivation and the avoidance motivation in the process of S33 in FIG. 13. The fourth part of the diagnosis processing corresponds to the process of S35 in FIG. 13. The fifth part of the diagnosis processing corresponds to the process of S37 and S38 in FIG. 13. In the example in FIGS. 14 to 18, a case where the result of the motivation determination processing illustrated in FIG. 10 and the result of the achievement determination processing illustrated in FIG. 12 are applied is illustrated.

First, a specific example of the process of S33 will be described with reference to FIGS. 14 to 16.

As illustrated in FIG. 14, in a case where a positive reward motivation is stimulated and the comparison result is UP, +1 is allocated to the record as a single motivation weight value of the reward motivation. In a case where a negative reward motivation is stimulated and the comparison result is DOWN, +1 is allocated to the record as a single motivation weight value of the reward motivation. In a case other than the above case, that is, in a case where a positive reward motivation is stimulated and the comparison result is DOWN, in a case where a negative reward motivation is stimulated and the comparison result is UP, or in a case where the reward motivation is not stimulated, 0 is allocated to the record as a single motivation weight value of the reward motivation.

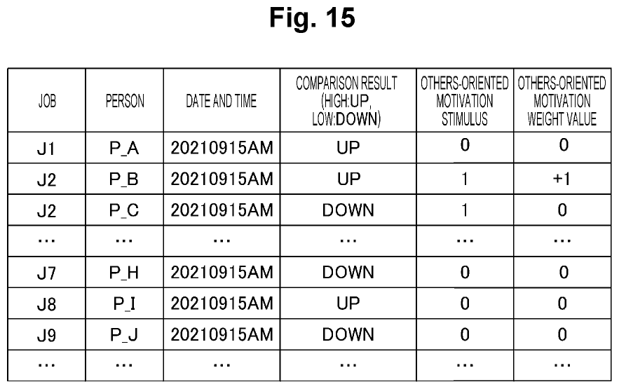

As illustrated in FIG. 15, in a case where the others-oriented motivation is stimulated and the comparison result is UP, +1 is allocated to the record as a single motivation weight value of the others-oriented motivation. In a case other than the above case, that is, in a case where the others-oriented motivation is stimulated and the comparison result is DOWN, or in a case where the others-oriented motivation is not stimulated, 0 is allocated to the record as a single motivation weight value of the others-oriented motivation.

Note that, although not illustrated, the way of allocating the single motivation weight values of the specialty motivation, the power motivation, the fear motivation, and the expectation motivation is equivalent to the case of the others-oriented motivation.

That is, in a case where the specialty motivation is stimulated and the comparison result is UP, +1 is allocated to the record as a single motivation weight value of the specialty motivation. In a case other than the above case, that is, in a case where the specialty motivation is stimulated and the comparison result is DOWN, or in a case where the specialty motivation is not stimulated, 0 is allocated to the record as a single motivation weight value of the specialty motivation.

In a case where the power motivation is stimulated and the comparison result is UP, +1 is allocated to the record as a single motivation weight value of the power motivation. In a case other than the above case, that is, in a case where the power motivation is stimulated and the comparison result is DOWN, or in a case where the power motivation is not stimulated, 0 is allocated to the record as a single motivation weight value of the power motivation.

In a case where the fear motivation is stimulated and the comparison result is UP, +1 is allocated to the record as a single motivation weight value of the fear motivation. In a case other than the above case, that is, in a case where the fear motivation is stimulated and the comparison result is DOWN, or in a case where the fear motivation is not stimulated, 0 is allocated to the record as a single motivation weight value of the fear motivation.

In a case where the expectation motivation is stimulated and the comparison result is UP, +1 is allocated to the record as a single motivation weight value of the expectation motivation. In a case other than the above case, that is, in a case where the expectation motivation is stimulated and the comparison result is DOWN, or in a case where the expectation motivation is not stimulated, 0 is allocated to the record as a single motivation weight value of the expectation motivation.

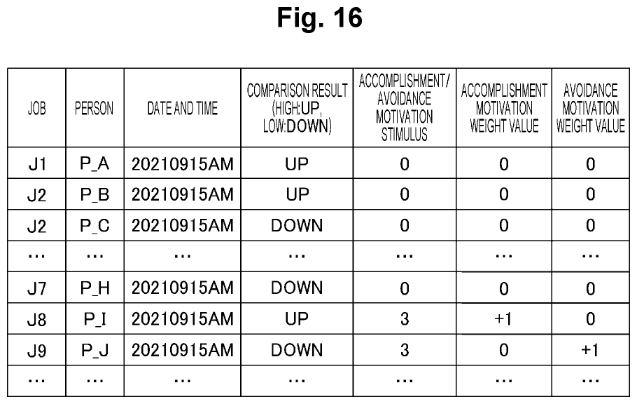

As illustrated in FIG. 16, in a case where the accomplishment/avoidance motivation is stimulated and the comparison result is UP, +1 is allocated to the record as a single motivation weight value of the accomplishment motivation. In a case where the accomplishment/avoidance motivation is stimulated and the comparison result is DOWN, +1 is allocated to the record as a single motivation weight value of the avoidance motivation. In a case other than the above case, that is, in a case where the accomplishment/avoidance motivation is not stimulated, 0 is allocated to the record as a single motivation weight value of the accomplishment motivation and the avoidance motivation.

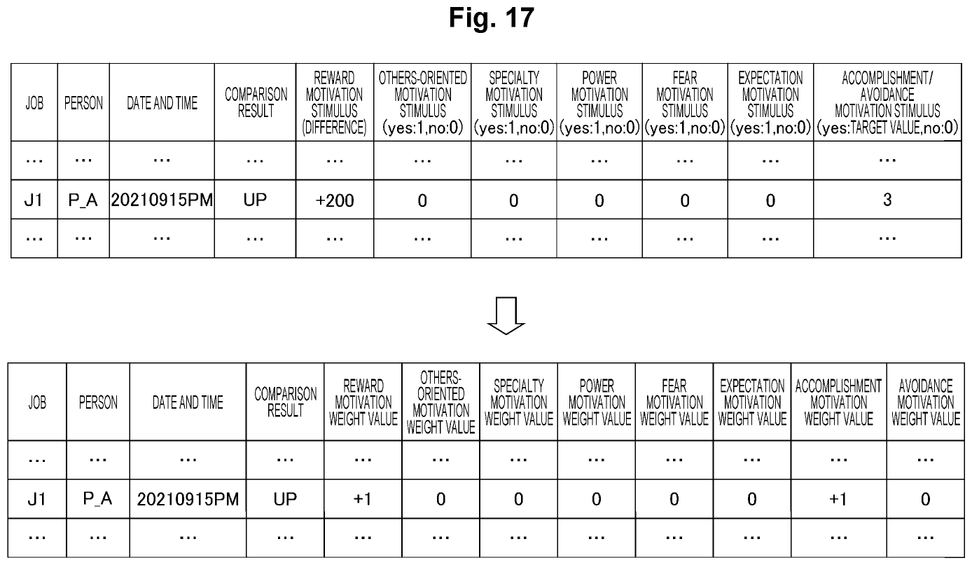

Next, a specific example of the process of S35 will be described with reference to FIG. 17.

As illustrated in FIG. 17, in a case where a plurality of motivation factors is stimulated, the single motivation weight value allocation processing described with reference to FIGS. 14 to 16 is executed for each motivation factor being stimulated.

In the example in FIG. 17, a record in which the reward motivation and the accomplishment/avoidance motivation are simultaneously stimulated is illustrated. In this case, allocation of each of the reward motivation weight value, the accomplishment motivation weight value, and the avoidance motivation weight value is executed as allocation processing of a multiple motivation weight value. That is, since the example in FIG. 17 corresponds to a case where a positive reward motivation is stimulated and the comparison result is UP, +1 is allocated to the record as a multiple motivation weight value of the reward motivation. Moreover, since the example corresponds to a case where the accomplishment/avoidance motivation is stimulated and the comparison result is UP, +1 is allocated to the record as a multiple motivation weight value of the accomplishment motivation.

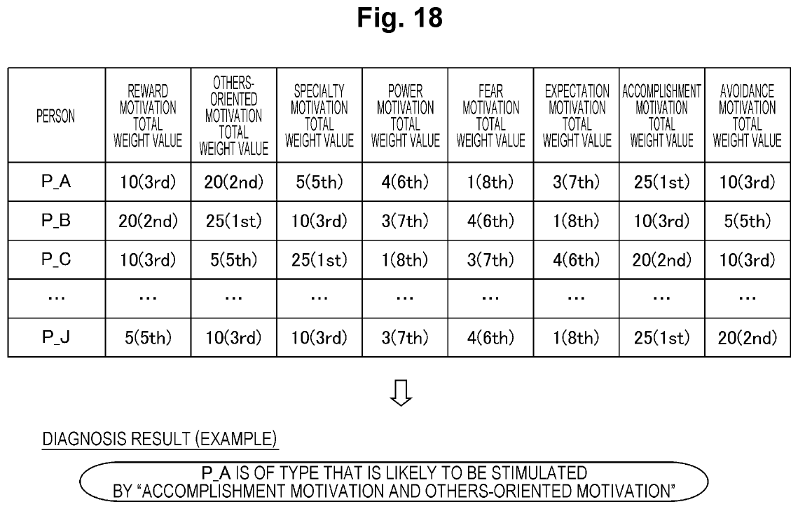

Next, a specific example of the process of S37 and S38 will be described with reference to FIG. 18.

As illustrated in the upper part of FIG. 18, the single motivation weight value and the multiple motivation weight value calculated for each motivation factor are added up for each person. The added-up weight value for each motivation factor is totalized as a total weight value in one record for each person. Thereafter, the total weight value for each motivation factor for each person is ranked in descending order. Then, the motivation factors with the top two total weight values are diagnosed as motivation factors (motivation type) with which the person is likely to be stimulated.

The example in FIG. 18 illustrates a case where the total weight values of the reward motivation, the others-oriented motivation, the specialty motivation, the power motivation, the expectation motivation, the accomplishment motivation, and the avoidance motivation of the person P_A are respectively 10, 20, 5, 4, 1, 3, 25, and 10. In this case, the motivation type of the person P_A is diagnosed as accomplishment motivation and others-oriented motivation.

As illustrated in the lower part of FIG. 18, the diagnosed motivation type is outputted in a format that is easy for the user to grasp. For example, the result of the diagnosis processing is outputted to the user in a sentence format such as ‘P_A is a type who is likely to be stimulated by “accomplishment motivation and others-oriented motivation”.’. As a result, the user can easily grasp what kind of motivation factor is likely to stimulate the person to be diagnosed.

### 2.4 Task Contrivance Proposal Processing

Next, task contrivance proposal processing in the personnel training support device according to the embodiment will be described.

### 2.4.1 Flowchart

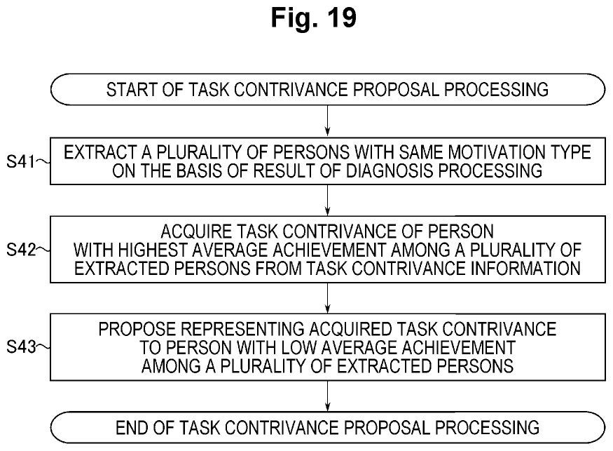

FIG. 19 is a flowchart illustrating an example of task contrivance proposal processing in the personnel training support device according to the embodiment. In the example in FIG. 19, it is assumed that the task contrivance information 33 is inputted in advance to the personnel training support device 1 by the user, and the diagnosis processing is executed in advance.

As illustrated in FIG. 19, when an instruction to execute the task contrivance proposal processing is received from the user (Start), the task contrivance proposal unit 27 extracts a plurality of persons with the same motivation type on the basis of the result of the diagnosis processing (S41).

The task contrivance proposal unit 27 acquires, from the task contrivance information 33, a task contrivance of a person with the highest average achievement among the plurality of persons extracted in the process of S41 (S42).

The task contrivance proposal unit 27 proposes, to the user, presenting the task contrivance acquired in the process of S42 to a person with a low average achievement among the plurality of persons extracted in the process of S41 (S43).

When the process of S43 ends, the task contrivance proposal processing ends (End).

### 2.4.2 Specific Example

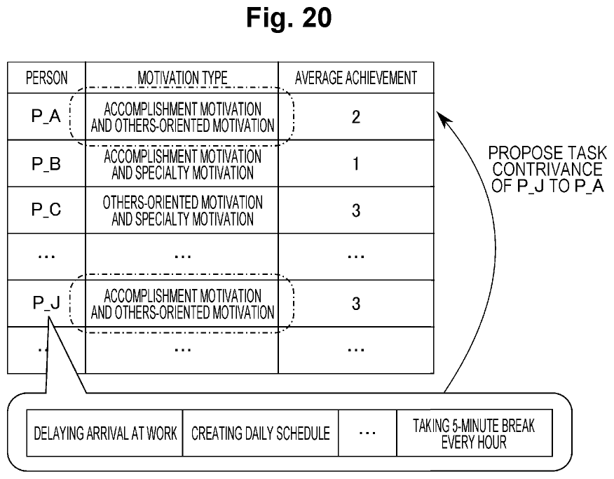

FIG. 20 is a diagram illustrating an example of task contrivance proposal processing in the personnel training support device according to the embodiment.

As illustrated in FIG. 20, for example, the persons P_A and P_J having “accomplishment motivation and others-oriented motivation” as a common motivation type are extracted in the process of S41.

Subsequently, the task contrivances (“Delaying arrival at work”, “Creating daily schedule”, . . . , and “Taking 5-minute break every hour”) of the person P_J having a high average achievement among the persons P_A and P_J is acquired from the task contrivance information 33 in the process of S42.

Then, a proposal of presenting the acquired task contrivance to the person P_A is outputted to the user in the process of S43. This makes it possible to propose a task contrivance of a person having a common motivation type among persons who have made high achievements. Therefore, it is possible to propose a task contrivance that is likely to lead to further improvement of the achievement and has high affinity for a person who receives the proposal.

Note that, for a person who has made the highest achievement, for example, it is only required to propose a task contrivance of a high performance person having the same motivation type in another organization. This makes it possible to propose an effective task contrivance to all persons.

### 2.5 Personnel Transfer Proposal Processing

Next, personnel transfer proposal processing in the personnel training support device according to the embodiment will be described.

### 2.5.1 Flowchart

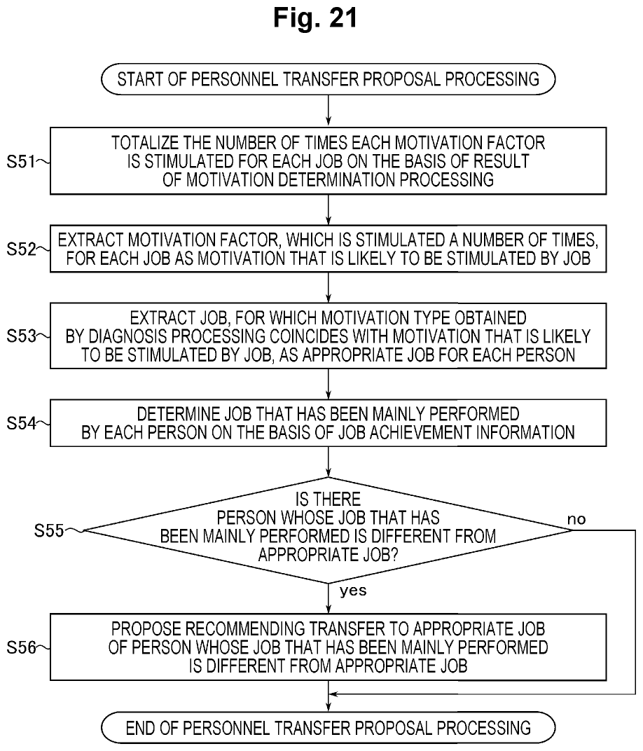

FIG. 21 is a flowchart illustrating an example of personnel transfer proposal processing in the personnel training support device according to the embodiment. In the example in FIG. 21, it is assumed that the diagnosis processing is executed in advance.

As illustrated in FIG. 21, when an instruction to execute the personnel transfer proposal processing is received from the user (Start), the personnel transfer proposal unit 28 totalizes the number of times each motivation factor is stimulated for each job on the basis of the result of the motivation determination processing (S51).

As a result of the totalization in the process of S51, the personnel transfer proposal unit 28 extracts a motivation factor, which is stimulated a number of times, for each job as a “motivation that is likely to be stimulated by the job” (S52).

The personnel transfer proposal unit 28 extracts a job, for which the “motivation that is likely to be stimulated by the job” extracted in the process of S52 coincides with the motivation type based on the result of the diagnosis processing, as an “appropriate job” for each person (S53).

The personnel transfer proposal unit 28 determines a “job that has been mainly performed” by each person on the basis of the job achievement information 32 (S54).

The personnel transfer proposal unit 28 determines whether there is a person whose “job that has been mainly performed” determined in the process of S54 is different from the “appropriate job” extracted in the process of S53 or not (S55).

In a case where there is a person whose “job that has been mainly performed” is different from the “appropriate job” (S55; yes), the personnel transfer proposal unit 28 proposes recommending a transfer of the person to the “appropriate job” to the user (S56). When the process of S56 ends, the personnel transfer proposal processing ends (End).

### 2.5.2 Specific Example

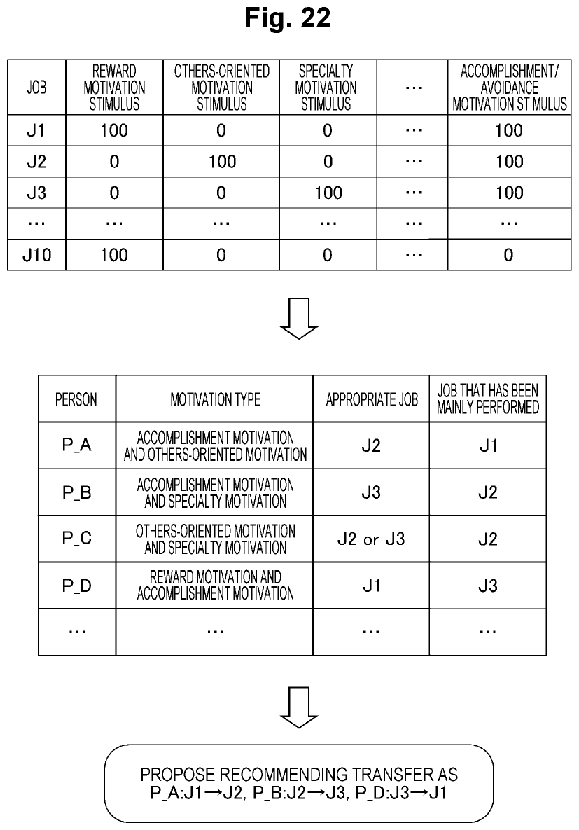

FIG. 22 is a diagram illustrating an example of personnel transfer proposal processing in the personnel training support device according to the embodiment.

As illustrated in the upper part of FIG. 22, the number of times each motivation factor is stimulated in the process of S51 is totalized for each job. In the example in FIG. 22, it is indicated that the job J1 has stimulated the reward motivation, and the accomplishment motivation or the avoidance motivation most. It is also indicated that the job J2 has stimulated the others-oriented motivation, and the accomplishment motivation or the avoidance motivation most. It is also indicated that the job J3 has stimulated the specialty motivation, and the accomplishment motivation or the avoidance motivation most.

As a result, the reward motivation, and the accomplishment motivation or the avoidance motivation are extracted as the motivation that is likely to be stimulated by the job J1 in the process of S52. The others-oriented motivation, and the accomplishment motivation or the avoidance motivation are extracted as the motivation that is likely to be stimulated by the job J2. The specialty motivation, and the accomplishment motivation or the avoidance motivation are extracted as the motivation that is likely to be stimulated by the job J3.

As illustrated in the middle part of FIG. 22, a job for which the motivation type coincides with the motivation that is likely to be stimulated is extracted as an appropriate job for each person in the process of S53. In the example in FIG. 22, the job J2 that is likely to stimulate a set of accomplishment motivation and others-oriented motivation is extracted as an appropriate job for the person P_A having a set of accomplishment motivation and others-oriented motivation as the motivation type. The job J3 that is likely to stimulate a set of accomplishment motivation and specialty motivation is extracted as an appropriate job for the person P_B having a set of accomplishment motivation and specialty motivation as the motivation type. The job J2 or J3 that is likely to stimulate a set of others-oriented motivation and specialty motivation is extracted as an appropriate job for the person P_C having a set of others-oriented motivation and specialty motivation as the motivation type. The job J1 that is likely to stimulate a set of reward motivation and accomplishment motivation is extracted as an appropriate job for the person P_D having a set of reward motivation and accomplishment motivation as the motivation type.

Moreover, a job that has been mainly performed is determined for each person in the process of S54. In the example in FIG. 22, it is indicated that jobs mainly performed by the persons P_A to P_D are respectively jobs J1, J2, J2, and J3.

As illustrated in the lower part of FIG. 22, the persons P_A, P_B, and P_D are determined as persons, for which the appropriate job is different from the job that has been mainly performed, in the process of S55.

Then, a proposal for recommending a transfer to the jobs J2, J3, and J1 that are likely to stimulate the same motivation as the motivation type to the persons P_A, P_B, and P_D is outputted to the user in the process of S56. This makes it possible to allocate a job that is likely to stimulate the motivation factor to each person.

### 2.6 Job Construction Proposal Processing

Next, job construction proposal processing in the personnel training support device according to the embodiment will be described.

### 2.6.1 Flowchart

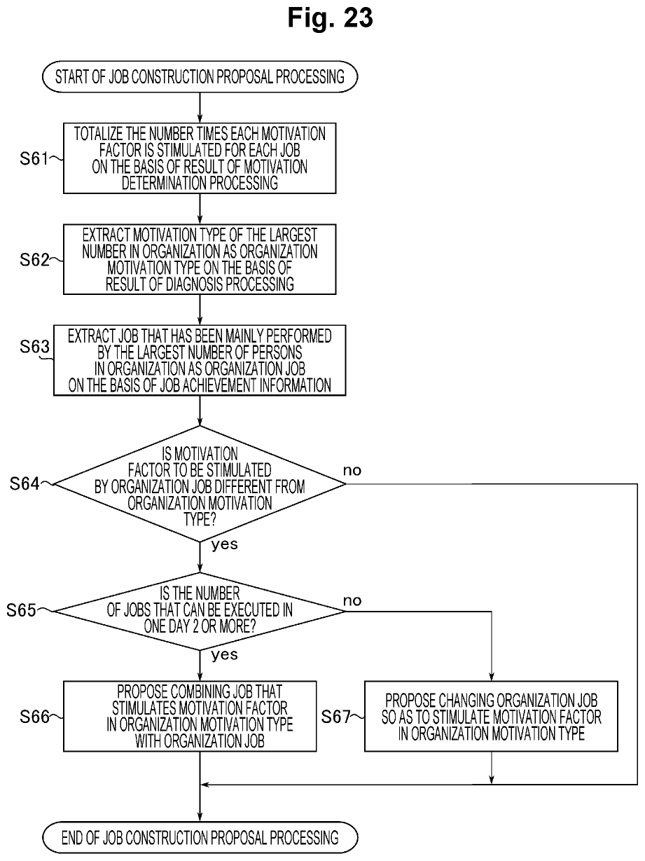

FIG. 23 is a flowchart illustrating an example of job construction proposal processing in the personnel training support device according to the embodiment. In the example in FIG. 23, it is assumed that the diagnosis processing is executed in advance.

As illustrated in FIG. 23, when an instruction to execute the job construction proposal processing is received from the user (Start), the job construction proposal unit 29 totalizes the number of times each motivation factor is stimulated for each job on the basis of the result of the motivation determination processing (S61). The process of S61 is equivalent to the process of S51 in FIG. 21.

The job construction proposal unit 29 extracts the motivation type of the largest number in the organization as an “organization motivation type” on the basis of the result of the diagnosis processing (S62).

The job construction proposal unit 29 extracts a job that has been mainly performed by the largest number of persons in the organization as an “organization job” on the basis of the job achievement information 32 (S63).

The job construction proposal unit 29 determines whether the motivation factor to be stimulated by the organization job extracted in the process of S63 is different from the motivation factor in the organization motivation type extracted in the process of S62 or not (S64).

In a case where the motivation factor to be stimulated by the organization job is different from the motivation factor in the organization motivation type (S64; yes), the job construction proposal unit 29 determines whether the number of jobs that can be executed in one day is 2 or more or not (S65).

In a case where the number of jobs that can be executed in one day is 2 or more (S65; yes), the job construction proposal unit 29 proposes, to the user, combining the job that stimulates the motivation factor in the organization motivation type extracted in the process of S61 with the organization job extracted in the process of S63 on the basis of the totalization result obtained in the process of S62 (S66).

In a case where the number of jobs that can be executed in one day is 1 (S65; no), the job construction proposal unit 29 proposes, to the user, changing the method of processing the organization job extracted in the process of S63 so as to stimulate the motivation factor in the organization motivation type extracted in the process of S62 on the basis of the totalization result obtained in the process of S61 (S67).

In a case where the motivation factor to be stimulated by the organization job coincides with the motivation factor in the organization motivation type (S64; no), in a case where the process of S66 ends, or in a case where the process of S66 ends, the job construction proposal processing ends (End).

### 2.6.2 Specific Example

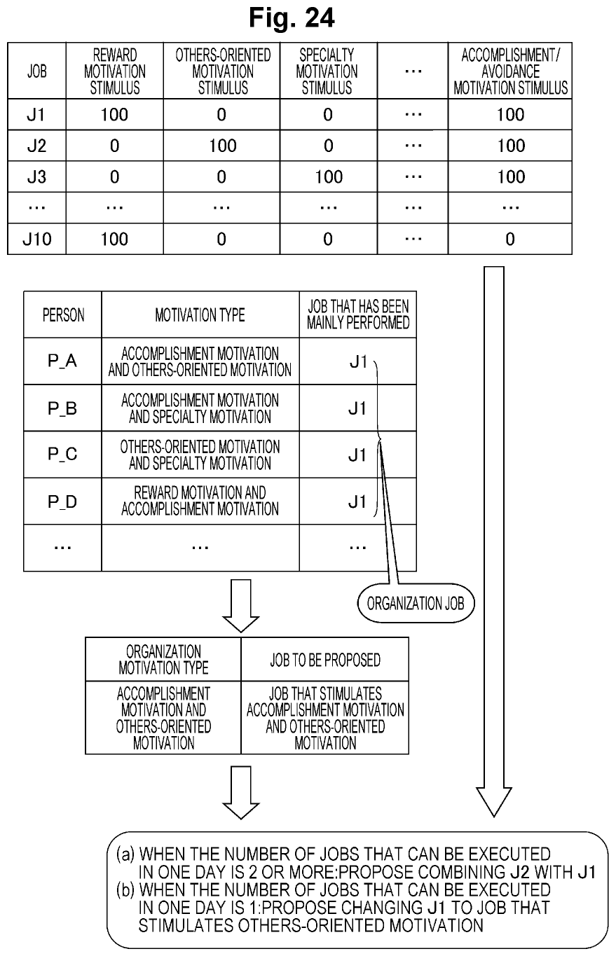

FIG. 24 is a diagram illustrating an example of job construction proposal processing in the personnel training support device according to the embodiment.

As illustrated in the top part of FIG. 24, the number of times each motivation factor is stimulated is totalized for each job in the process of S61. The example in the top part of FIG. 24 is equivalent to the example in the top part of FIG. 22, and thus description thereof is omitted here.

As illustrated in the second and third parts from the top in FIG. 24, the organization motivation type is extracted in the process of S62. In the example in FIG. 24, a case where a motivation type having a set of accomplishment motivation and others-oriented motivation is determined to be the most prevalent motivation type in an organization is illustrated. In this case, the job to be proposed in the job construction proposal processing is a job that stimulates a motivation factor in the organization motivation type.

Moreover, an organization job is extracted in the process of S63. In the example in FIG. 24, a case where the job J1 that has been mainly performed by the persons P_A to P_D is determined as an organization job that has been mainly performed by the largest number of persons in the organization is illustrated.

In this case, a motivation factor to be stimulated by the organization job J1 is the reward motivation and the accomplishment/avoidance motivation. Therefore, it is determined that the motivation factor to be stimulated by the organization job J1 is different from the motivation factor in the organization motivation type in the process of S64.

As illustrated at the bottom part of FIG. 24, a proposal of a job that stimulates the motivation factor in the organization motivation type is outputted to the user in the process of S66 or S67. Specifically, in a case where the number of jobs that can be executed in one day is 2 or more, construction of a new job that can stimulate the others-oriented motivation by combining the job J2 with the organization job J1 is proposed to the user. Moreover, in a case where the number of jobs that can be executed in one day is 1, it is proposed to the user to change the organization job J1 to a job that can stimulate the others-oriented motivation. This makes it possible to stimulate motivation factors of a larger number of persons.

### 3. Effects According to Embodiment

According to the embodiment, the organization unit 20 associates the first feature amount corresponding to the reward motivation, the others-oriented motivation, the specialty motivation, the power motivation, the fear motivation, and the expectation motivation for each job on the basis of the task content information 30. The organization unit 20 associates the second feature amount corresponding to the accomplishment motivation or the avoidance motivation for each set of a job, a person, and a date and time on the basis of the challenge content information 31. On the basis of the first feature amount and the second feature amount, the motivation factor determination unit 21 determines whether each motivation factor is stimulated or not for each set of a job, a person, and a date and time. This makes it possible to visualize what kind of stimulus each job gives to each person at a certain date and time. Therefore, it is possible to grasp a condition under which the motivation factor is stimulated with fine granularity. Accordingly, it is possible to obtain information for objectively determining what feature of the job motivates a person.

Moreover, the achievement determination unit 23 determines whether the achievement exceeds an average achievement for each set of a job, a person, and a date and time or not on the basis of the job achievement information 32. The motivation type diagnosis unit 26 diagnoses the top two motivation factors, with which a person is likely to be stimulated, as the motivation type for each person on the basis of the results of the motivation determination processing and the achievement determination processing. As a result, the motivation type diagnosis unit 26 can output, to the user, what kind of motivation factor a person is likely to be stimulated with. Therefore, the user can objectively determine the influence of the difference in the motivation factor for each person on the achievement.

Moreover, the task contrivance proposal unit 27 extracts a plurality of persons diagnosed to have the same motivation type. The task contrivance proposal unit 27 proposes, to the user, presenting a task contrivance of a person who has made a high achievement among the plurality of extracted persons to another person. This makes it possible to propose an efficient task contrivance for maximizing the achievement for each person by utilizing the fact that a person stimulated by a similar motivation is likely to make more achievements when performing similar behavior.

Moreover, the personnel transfer proposal unit 28 extracts a motivation factor that is likely to be stimulated by a job for each job on the basis of the result of the motivation determination processing. The personnel transfer proposal unit 28 extracts a job that has been mainly performed by a person for each person on the basis of the job achievement information 32. In a case where there is a person whose motivation factor that is likely to be stimulated by the job that has been mainly performed is different from the motivation type, the personnel transfer proposal unit 28 proposes, to the user, recommending a transfer to a job that is likely to stimulate the motivation type of the person. This makes it possible to suitably allocate a job that is likely to stimulate the motivation factor to each person.

Moreover, the job construction proposal unit 29 extracts a motivation factor that is likely to be stimulated by the job for each job on the basis of the result of the motivation determination processing. The job construction proposal unit 29 extracts a job that has been mainly performed by the largest number of persons in an organization, as an organization job on the basis of the job achievement information 32. The job construction proposal unit 29 extracts the motivation type that stimulates the largest number of persons in the organization as the organization motivation type on the basis of the result of the diagnosis processing. In a case where a motivation factor that is likely to be stimulated by the organization job is different from the motivation factor in the organization motivation type, and the number of jobs that can be executed in one day is 2 or more, the job construction proposal unit 29 proposes, to the user, combining a job that is likely to stimulate the organization motivation type with the organization job. Moreover, in a case where the motivation factor that is likely to be stimulated by the organization job is different from the motivation factor in the organization motivation type, and the number of jobs that can be executed in one day is 1, the job construction proposal unit 29 proposes, to the user, changing the organization job to a job that is likely to stimulate to the motivation factor in the organization motivation type. This makes it possible to make a job that the manager wants to perform closer to a job that a person wants to perform. This makes it possible to efficiently stimulate the motivation factor of a person and improve the achievement in the job-type task.

### 4. Others

Note that various modifications can be made in the embodiment described above.

For example, although a case where the motivation type diagnosis unit 26 diagnoses the motivation type on the basis of only the task content information 30, the challenge content information 31, and the job achievement information 32 has been described in the above embodiment, the present invention is not limited thereto. For example, in a case where information of a single motivation weight value and a multiple motivation weight value calculated in the past is stored for each person, the motivation type diagnosis unit 26 may diagnose the motivation type by adding information of the weight value to a weight value calculated from the task content information 30, the challenge content information 31, and the job achievement information 32.

For example, although a case where various programs of personnel training support operation are executed by the personnel training support device 1 has been described in the above embodiment, the present invention is not limited thereto. For example, various programs of the personnel training support operation may be executed by calculation resources on a cloud.

Note that the present invention is not limited to the embodiment described above, and various types of modifications can be made at an implementation stage without departing from the gist of the invention. Moreover, embodiments may be implemented in a combination as required, and in that case, effects can be obtained by combination. Furthermore, the embodiment described above includes various inventions, and various inventions can be extracted by combinations selected from a plurality of disclosed components. For example, even if some components are deleted from all the components described in the embodiments, a configuration from which the components have been deleted can be extracted as an invention in a case where the problem can be solved and the advantageous effects can be obtained.

### REFERENCE SIGNS LIST

1 Personnel training support device
10 Control circuit
11 Memory
12 Communication module
13 User interface
14 Drive
15 Storage medium
20 Organization unit
21 Motivation factor determination unit
22 Average achievement calculation unit
23 Achievement determination unit
24 Single motivation weight value calculation unit
25 Multiple motivation weight value calculation unit
26 Motivation type diagnosis unit
27 Task contrivance proposal unit
28 Personnel transfer proposal unit
29 Job construction proposal unit
30 Task content information
31 Challenge content information
32 Job achievement information
33 Task contrivance information

1. A personnel training support device comprising:
an organization unit, comprising one or more processors, configured to associate a first feature amount corresponding to at least one first motivation factor for each job on a basis of first information indicating task content for each job, and
associate a second feature amount corresponding to at least one second motivation factor for each set of a job, a person, and a date and time on a basis of second information indicating a challenge content for each set of a job, a person, and a date and time; and
a first determination unit, comprising one or more processors, configured to
determine whether each of the first motivation factor and the second motivation factor is stimulated or not for each set of a job, a person, and a date and time on a basis of the first feature amount and the second feature amount.

2. The personnel training support device according to claim 1, further comprising:
a second determination unit, comprising one or more processors, configured to determine whether the achievement has exceeded a threshold or not for each set of a job, a person, and a date and time on a basis of third information indicating an achievement for each set of a job, a person, and a date and time; and
a diagnosis unit, comprising one or more processors, configured to diagnose at least one third motivation factor, with which a person is likely to be stimulated, for each person on a basis of a result of determination by the first determination unit and a result of determination by the second determination unit.

3. The personnel training support device according to claim 2,
further comprising a first proposal unit, comprising one or more processors, configured to
extract a first person and a second person diagnosed to have a same third motivation factor, and
propose presenting a task contrivance of one of a first person and a second person who has achieved a higher achievement to the other.

4. The personnel training support device according to claim 2,
further comprising a second proposal unit, comprising one or more processors, configured to
extract at least one fourth motivation factor that is likely to be stimulated by a job for each job on a basis of a result of determination by the first determination unit,
extract a job that has been mainly performed by a person for each person on a basis of the third information, and
propose recommending a third person to transfer to a job that is likely to stimulate the third motivation factor of the third person in a case where the third motivation factor of the third person does not coincide with the fourth motivation factor of a job that has been mainly performed by the third person.

5. The personnel training support device according to claim 2,
further comprising a third proposal unit, comprising one or more processors, configured to
extract at least one fourth motivation factor that is likely to be stimulated by a job for each job on a basis of a result of determination by the first determination unit,
extract a job that has been mainly performed by a largest number of persons on a basis of the third information,
extract at least one fifth motivation factor that stimulates a largest number of persons on a basis of a diagnosis result obtained by the diagnosis unit, and
propose combining a job that is likely to stimulate the fifth motivation factor with the extracted job in a case where the fourth motivation factor of the extracted job and the fifth motivation factor do not coincide with each other.

6. The personnel training support device according to claim 2,
further comprising a fourth proposal unit, comprising one or more processors, configured to
extract at least one fourth motivation factor that is likely to be stimulated by a job for each job on a basis of a result of determination by the first determination unit,
extract a job that has been mainly performed by a largest number of persons on a basis of the third information,
extract at least one fifth motivation factor that stimulates a largest number of persons on a basis of a diagnosis result obtained by the diagnosis unit, and
propose changing the extracted job to a job that is likely to stimulate the fifth motivation factor in a case where the fourth motivation factor of the extracted job and the fifth motivation factor do not coincide with each other.

7. A personnel training support method comprising:
determining at least one first motivation factor to be stimulated by a job on a basis of first information for identifying the job; and
determining at least one second motivation factor to be stimulated by a job for each person and each date and time on a basis of second information set for each person and each date and time regarding an achievement of the job.

8. A non-transitory computer readable medium storing a program, wherein execution of the program causes a computer to function as a personnel training support device according to claim 1.
